(19) United States
(12) Patent Application Publication
(10) Pub. No.: US 2001/0053260 A1
(43) Pub. Date: Dec. 20, 2001

(54) Optical module and method for producing the same, and optical circuit device

(76) Inventors: Toshiyuki Takizawa, Shiga (JP); Masato Ishino, Osaka (JP); Masahiro Kito, Osaka (JP)

Correspondence Address: NIXON PEABODY, LLP, 8180 GREENSBORO DRIVE, SUITE 800, MCLEAN, VA, 22102, US

(21) Appl. No.: 09/804,072

(22) Filed: Mar. 13, 2001

(30) Foreign Application Priority Data
Mar. 13, 2000 (JP) 2000-069363

(51) Int. Cl. G02B 6/12; G02B 6/30

(52) U.S. Cl. 385/14; 385/49

(57) ABSTRACT

An optical module includes a substrate, a waveguide body disposed on the substrate and including an optical waveguide for propagating light, and a photodetector. A curved portion for radiating light propagating through the optical waveguide from the optical waveguide is provided in a part of the optical waveguide, and the photodetector receives light radiated by the curved portion.

### BACKGROUND OF THE INVENTION

The present invention relates to an optical module and a method for producing the same, and an optical circuit device. In particular, the present invention relates to an optical module used suitably as a light-receiving module (optical communication module).

In order to develop a fiber optical subscriber communication network in advanced information society, a photoactive element typified by a semiconductor laser, an optical function module including the photoactive element, and the like have been under development. In the future, it is expected that optical fibers are extended to each house, and optical communication terminals are widely used even in each house, and thus the communication network is expanded. To achieve this wide communication network, there is a demand for low cost optical communication terminals.

A module as an optical communication terminal requires a function to receive signal light and a function to send out signal light. A semiconductor laser is used for the function to send out signal light, and a photodetector (light-receiving element) is used for the function to receive signal light. As modules for receiving and sending out signal light, various structures have been proposed. In particular, when the wavelength of the light to be received is different from that of the light to be sent out, it is necessary to separate each light by the wavelength reliably. In this context, various module structures having such a function have been proposed. For example, Japanese Laid-Open Patent Publication (Tokkai-Hei) No. 9-211243 discloses a light-receiving module having such a structure.

FIG. 22 shows a structural outline of a light-receiving module disclosed in Japanese Laid-Open Patent Publication (Tokkai-Hei) No. 9-211243. The light-receiving module shown in FIG. 22 includes one optical waveguide 101 provided on a substrate 107, and a filter 105 having a wavelength selectivity provided in the middle of the optical waveguide 101. One end of the optical waveguide 101 serves as an incident terminal 106 provided on the end face of the substrate 107, and signal light is incident from this incident terminal 106. The other end of the optical waveguide 101 faces a photodetector 104 provided on the substrate 107.

The filter 105 provided on the substrate 107 reflects light of 1.3 μm and transmits light of 1.5 μm, for example. Light of a wavelength of 1.3 μm mixed with light of a wavelength of 1.5 μm is incident from the incident terminal 106 to the optical waveguide 101. The light of a wavelength of 1.3 μm of the incident light is reflected by the filter 105 and the light of a wavelength of 1.5 μm passes through the filter 105 and is received by the photodetector 104. The light received by the photodetector 104 is converted to an electrical signal. On the other hand, the light of a wavelength of 1.3 μm reflected by the filter 105 enters a second optical waveguide 102 provided between the filter 105 and the end face of the substrate 107, propagates through the second waveguide 102 and emits from the end face of the substrate 107.

In the conventional light-receiving module shown in FIG. 22, it is necessary to insert the filter 105 in a groove provided in the substrate 107. Therefore, when producing the light-receiving module, a process for forming a groove for inserting the filter 105 in the substrate 107 and a process for inserting the filter 105 into the groove are required, so that the production process is complicated and the module cannot be produced easily. In addition, the thickness of the filter 105 is generally as thin as on the order of ten μm, so that it is not easy to insert the filter 105 mechanically in the groove provided in the substrate 107, which leads to a poor production efficiency.

Another structure that has been proposed is as follows. A dielectric multilayered film is formed on the end face of the optical waveguide from which signal light emits, and a wavelength selectivity function is achieved by this dielectric multilayered film. However, in such a structure, after a substrate provided with an optical waveguide is formed to a predetermined shape, it is necessary to form a dielectric multilayered film on the end face of the substrate, which makes it difficult to achieve efficient mass production, unlike a regular semiconductor production process.

### SUMMARY OF THE INVENTION

In view of the foregoing problems, it is an object of the present invention to provide an optical module that can be produced easily without requiring a complicated assembly process, and a method for producing the same.

An optical module of the present invention includes a substrate; a waveguide body disposed on the substrate, the waveguide body and including an optical waveguide for propagating light; and a photodetector, wherein curved portion for radiating light propagating through the optical waveguide from the optical waveguide is provided in a part of the optical waveguide, and the photodetector receives light radiated by the curved portion.

In one preferable embodiment of the present invention, a step portion including an inclined surface is provided in a part of the substrate, the curved portion of the optical waveguide is a site at which the optical waveguide is curved by the step portion, and light radiated from the optical waveguide is reflected by the inclined surface of the step portion and is received by the photodetector.

In another preferable embodiment of the present invention, the optical waveguide is formed in a groove provided in the substrate, and the inclined surface is positioned in the groove.

In still another preferable embodiment of the present invention, a recess for curving the optical waveguide downward is provided in a vicinity of a lower portion of the inclined surface in the substrate.

In yet another preferable embodiment of the present invention, the inclined surface of the step portion is recessed in a form of a concave so that reflected light is collected to the photodetector.

In another preferable embodiment of the present invention, the optical waveguide does not extend up to a height more than an upper end of the inclined surface, and an end of the optical waveguide is present within a range between a height of the upper end and a height of a lower end of the inclined surface.

In still another preferable embodiment of the present invention, a width of the groove is increased from a lower portion to an upper portion of the inclined surface.

In yet another preferable embodiment of the present invention, a refractive index of a portion of the substrate that constitutes the inclined surface is lower than that of the optical waveguide, and the inclined surface is disposed in the groove under conditions for total reflection of light radiated from the optical waveguide.

In another preferable embodiment of the present invention, a reflective film for reflecting light radiated from the optical waveguide is formed on a surface of the inclined surface.

In still another preferable embodiment of the present invention, a diffraction grating is formed on a surface of the inclined surface.

In yet another preferable embodiment of the present invention, a dielectric multilayered film obtained by laminating layers having different dielectric constants is formed on a surface of the inclined surface.

In another preferable embodiment of the present invention, the optical waveguide is formed in a groove provided in the substrate, a protrusion or a recess for curving the optical waveguide downward or upward is formed in a part of a bottom surface of the groove, and the photodetector is provided in a position that is reached by light radiated from the curved portion formed in the protrusion or the recess.

In still another preferable embodiment of the present invention, a plurality of protrusions or recesses with respect to one optical waveguide are formed, and a plurality of photodetectors are provided corresponding to the plurality of protrusions or recesses.

In yet another preferable embodiment of the present invention, the optical module further includes a light collecting member for collecting light, wherein the light collecting member collects light radiated from the curved portion and to be received by the photodetector, and the photodetector receives the collected light via the light collecting member.

In another preferable embodiment of the present invention, wherein the light collecting member is selected from the group consisting of a convex lens, a concave lens, and a Fresnel lens.

In still another preferable embodiment of the present invention, the light collecting member is a member having a light collecting function and made of a material having a different refractive index from that of a portion surrounding the light collecting member.

In yet another preferable embodiment of the present invention, the optical module further includes an optical functional member for selectively transmitting or absorbing light of a specific wavelength, wherein the optical functional member is a dielectric multilayered film obtained by laminating layers having different dielectric constants, and the photodetector receives light radiated by the curved portion via the optical functional member.

In another preferable embodiment of the present invention, the optical module further includes an optical functional member for selectively transmitting or absorbing light of a specific wavelength, wherein the optical functional member is made of a material that absorbs only a specific wavelength, and the photodetector receives light radiated by the curved portion via the optical functional member.

In still another preferable embodiment of the present invention, a light-shielding portion for shielding light is provided in a periphery of the inclined surface, and the light-shielding portion shields light scattered after reflected by the inclined surface.

In yet another preferable embodiment of the present invention, the light-shielding portion is made of a material absorbing light.

In another preferable embodiment of the present invention, the light-shielding portion is a groove portion provided in the substrate.

According to another aspect of the present invention, an optical module includes a substrate; a waveguide body disposed on the substrate, the waveguide body including an optical waveguide for propagating light; and a photodetector, wherein the optical waveguide includes an end face from which the light propagating through the optical waveguide emits from the optical waveguide, an inclined surface for reflecting the light that has emited from the end face to the photodetector is provided on the substrate, and the photodetector receives light reflected by the inclined surface.

In one preferable embodiment of the present invention, a medium made of a material absorbing light of a specific wavelength is provided between the inclined surface and the photodetector.

In another preferable embodiment of the present invention, a light-shielding portion for shielding light is provided in a periphery of the inclined surface, and the light-shielding portion shields light scattered after reflected by the inclined surface.

According to another aspect of the present invention, an optical circuit device includes a light source; an optical waveguide for propagating light emitted from the light source; and a photodetector, wherein a curved portion for radiating the light propagating through the optical waveguide is provided in the optical waveguide, and the photodetector receives light radiated by the curved portion.

In one preferable embodiment of the present invention, the light source is a semiconductor laser device, the optical waveguide is a planar lightwave circuit, the photodetector is a photodiode, the light source, the optical waveguide and the photodetector are provided on a platform, thereby constituting an optical integrated circuit, and the optical integrated circuit further comprises at least one selected from the group consisting of a splitter, an optical multi/demultiplexer, a semiconductor amplifier, a switch and a modulator.

According to another aspect of the present invention, a method for producing an optical module includes the steps of:

preparing a substrate; forming a groove on an upper surface of the substrate, the groove including a wall surface that is one end of the groove and an inclined surface inclining with respect to a normal line of the substrate; depositing sequentially a material for a clad layer and a material for an optical waveguide on a bottom surface of the groove and the inclined surface, thereby forming the optical waveguide having a curved portion in a step including the bottom surface of the groove and the inclined surface; and providing a photodetector for receiving light radiated by the curved portion of the optical waveguide in a position that is reached by the light on the substrate surface.

In one preferable embodiment of the present invention, the step of preparing the substrate is a step of preparing a semiconductor substrate, the step of forming a groove includes a step of performing an anisotropic etching treatment with respect to the substrate, and the material for the optical waveguide is a polymer material.

In another preferable embodiment of the present invention, the step of preparing the substrate is a step of preparing a glass substrate, and a step of forming a reflective film on the inclined surface is performed after the step of forming the groove and before the step of forming the optical waveguide.

Thus, the present invention can provide an optical module in which the curved portion is formed in a part of the optical waveguide and light radiated by the curved portion is received by the photodetector. Therefore, the optical module having excellent mass productivity that is advantageous to achieve low cost can be provided.

This and other advantages of the present invention will become apparent to those skilled in the art upon reading and understanding the following detailed description with reference to the accompanying figures.

### BRIEF DESCRIPTION OF THE DRAWINGS

FIG. 1 is a schematic cross-sectional view showing the structure of an optical module of Embodiment 1 of the present invention.

FIG. 2 is a cross-sectional view taken along line II-II of FIG. 1.

FIG. 3 is a schematic perspective view showing the structure of an optical waveguide 22 of the optical module of Embodiment 1.

FIG. 4 is a schematic top view showing the structure of the optical module of Embodiment 1.

FIG. 5 is a schematic top view for illustrating a variation of the structure shown in FIG. 4.

FIG. 6 is a cross-sectional view for illustrating a variation of the structure of the optical module of Embodiment 1.

FIGS. 7A to 7E are cross-sectional views of a process sequence for illustrating a method for producing the optical module of Embodiment 1.

FIG. 8 is a schematic cross-sectional view showing the structure of a photodetector 30.

FIG. 9 is a schematic cross-sectional view showing the structure of an optical module of Embodiment 2.

FIG. 10 is a schematic cross-sectional view showing the structure of an optical module of Embodiment 3.

FIG. 11 is a schematic cross-sectional view showing the structure of an optical module of Embodiment 4.

FIG. 12 is a schematic cross-sectional view showing the structure of an optical module of Embodiment 5.

FIG. 13 is a schematic perspective view showing the structure of an optical waveguide 22 of the optical module of Embodiment 6.

FIG. 14 is a schematic cross-sectional view showing the structure of an optical module of Embodiment 7.

FIG. 15 is a schematic cross-sectional view showing the structure of the periphery of the photodetector 30 of an optical module of Embodiment 8.

FIG. 16 is a schematic cross-sectional view showing the structure of the periphery of the photodetector 30 of the optical module of Embodiment 8.

FIG. 17 is a schematic cross-sectional view showing the structure of the periphery of the photodetector 30 of the optical module of Embodiment 8.

FIG. 18 is a schematic cross-sectional view showing the structure of the periphery of the photodetector 30 of an optical module of Embodiment 9.

FIG. 19 is a schematic cross-sectional view showing the structure of the periphery of the photodetector 30 of an optical module of Embodiment 10.

FIG. 20 is a schematic perspective view showing the structure of the periphery of the optical waveguide 22 and the inclined surface 12 of an optical module of Embodiment 11.

FIG. 21 is a schematic perspective view showing the structure of the periphery of the optical waveguide 22 and the inclined surface 12 of the optical module of Embodiment 11.

FIG. 22 is a schematic top view showing the structure of a conventional optical module.

### DETAILED DESCRIPTION OF THE INVENTION

Hereinafter, embodiments of the present invention will be described with reference to the accompanying drawings. For simplification, the elements having substantially the same function bear the same reference numeral in the following drawings. The present invention is not limited to the following embodiments.

Embodiment 1

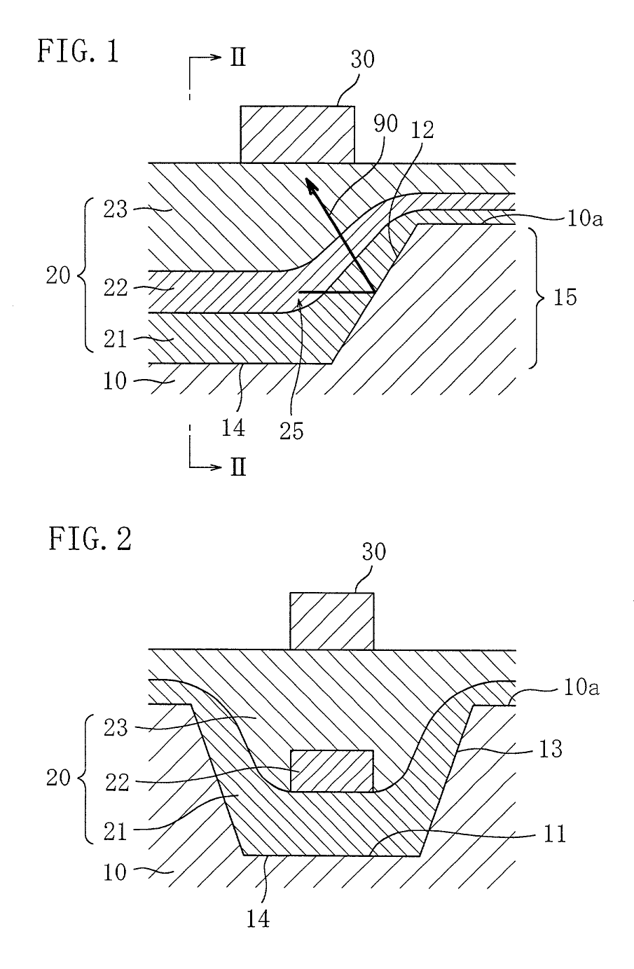

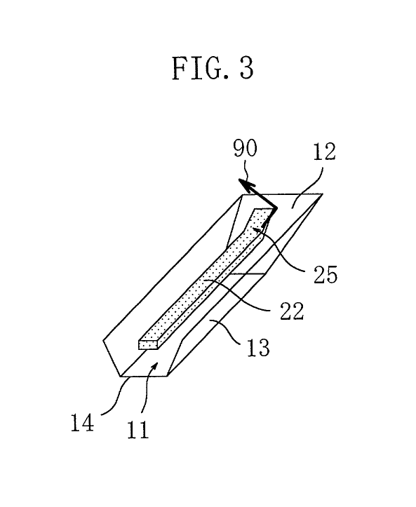

Referring to FIGS. 1 to 3, an optical module of an embodiment of the present invention will be described. FIG. 1 is a schematic view showing a structure of an optical module in its cross-section taken along the longitudinal direction of an optical waveguide. FIG. 2 is a schematic view showing a structure of the optical module in its cross-section taken along line II-II in FIG. 1. FIG. 3 is a perspective view for illustrating the structure of the optical waveguide.

The optical module of this embodiment includes a substrate 10 and a waveguide body 20 disposed on the substrate 10 and including an optical waveguide 22 for propagating light. The substrate 10 of this embodiment is a silicon substrate made of silicon. The waveguide body 20 includes layers of a lower clad 21, an optical waveguide (core) 22, and an upper clad 23 that are formed in this order from the bottom. The refractive index of the optical waveguide 22 is set to be slightly higher than those of the lower and upper clads 21 and 23 surrounding the optical waveguide 22, and among the light incident to the optical waveguide 22, the light that satisfies total reflection conditions at the interfaces with the lower and upper clad layers 21 and 23 propagates through the optical waveguide 22.

A curved portion 25 for radiating the light propagating through the optical waveguide 22 from the optical waveguide 22 is provided in a part of the optical guide wave path 22. Light (optical signal) 90 radiated from the optical waveguide 22 by the curved portion 25 is received by a photodetector (light-receiving element) 30 provided on the upper clad 23, and then is converted to an electrical signal. The photodetector 30 is constituted by, for example, a photodiode. The “curved portion” used in the specification of the present invention refers to not only a curved portion, but also a bent portion.

In this embodiment, a step portion 15 including an inclined surface 12 is formed in a part of the substrate 10, and the curved portion 25 of the optical waveguide 22 is formed by the step portion 15. In other words, the curved portion 25 of the optical waveguide 22 is a portion at which the optical waveguide 22 is curved by the step portion 15. The light 90 radiated from the optical waveguide 22 by the curved portion 25 reflects at the inclined surface 12 of the step portion 15 and is received by the photodetector 30. Thus, the optical waveguide 22 and the photodetector 30 in the optical module of this embodiment are optically coupled each other.

In this embodiment, the etching anisotropy of the silicon substrate 10 is utilized to expose the (111) plane of the silicon, so that a smooth inclined surface 12 is formed. In the case where the inclined surface 12 is formed so as to be smooth, in other words, in the case where the inclined surface 12 is formed so as to be a specular surface, the scattering of the single light 90 reflected at the inclined surface 12 can be suppressed. Therefore, the light can be received by the photodetector 30 reliably. As a result, the signal light propagating through the optical waveguide 22 can be received by the photodetector 30 efficiently.

Furthermore, a wavelength filter can be formed on the surface of the inclined surface 12. In such a structure, it is possible to reflect only a specific wavelength selectively, so that this structure can be used suitably as a demultiplexer in wavelength division multiplex (WDM) communication. When a wavelength filter is formed on the surface of the inclined surface 12, a process for mechanically inserting the filter 105 in the groove in the substrate 107 as shown in FIG. 22 can be omitted, so that the production efficiency can be improved. As the wavelength filter formed on the inclined surface 12, a dielectric multilayered film obtained by laminating layers having different dielectric constants can be used. Alternatively, a diffraction grating can be formed on the surface of the inclined surface 12.

A groove 11 is formed in the substrate 10, and the portion of the optical wavelength path 22 that transmits light is formed in the groove 11. In the case where the optical wavelength path 22 is positioned in the groove 11, the following advantages can be provided. The single light 90 radiated from the optical waveguide 22 by the curved portion 25 is scattered by various factors, and radiated in various directions. However, in the case where the optical waveguide 22 is positioned in the groove 11 as in this embodiment, scattered light of the light signal radiated from the optical waveguide 22 can be confined within the groove 11, so that light can be prevented from being scattered to the periphery. As a result, the scattered light can be prevented from being received by optical components arranged in the periphery of the substrate 10, and the effect of the light signal on other optical components arranged in the periphery of the substrate 10 can be effectively eliminated. Furthermore, the groove 11 in this embodiment is formed selectively in a relatively narrow portion in the vicinity of the surface of the substrate 10, so that in a process after the optical waveguide 22 is formed in the groove 11, it is easy to obtain a smooth surface of the upper clad 23, which is the surface of the waveguide body 20.

In the optical module of this embodiment, a wall surface of the groove that is an end of the groove 11 is the inclined surface 12 that reflects the radiated light 90 from the optical waveguide 22. The other end (not shown) of the groove is exposed from the end face (side surface) of the substrate 10 and is a free end. The groove 11 is formed, for example, by etching the substrate 10. In this embodiment, the groove 11 is designed to have an inverted trapezoid shaped cross-section. In this embodiment, the groove 11 is formed by etching, but the present invention is not limited thereto, and the groove 11 can be formed by physical processing.

In the case where the inverted trapezoidal groove 11 is formed, as in this embodiment, the angle formed by the wall surface 13 along the longitudinal direction of the groove 11 and the upper surface 10a of the substrate and the angle formed by the wall surface 13 and the bottom surface 14 of the substrate can be obtuse angles, so that the waveguide body 20 (21, 22 and 23) can be formed by spin-coating easily. The wall surface 13 may be inclined by 10° to 60° with respect to the normal line of the substrate 10. Moreover, it is not necessary to incline the wall surface 13 to form the inverted trapezoidal groove 11, and the wall surface 13 may be substantially perpendicular so that the cross-section of the groove 11 can be rectangular.

The waveguide body 20 in this embodiment is formed by laminating organic material (polymer material) on the substrate 10 by spin-coating. The lower clad 21 that is a lower layer of the waveguide body 20 is formed so as to cover the bottom surface 14, the wall surface 13, the inclined surface 12, and the upper surface 10a of the substrate. The optical waveguide (core) 22 having a substantially rectangular cross-section is formed on the lower clad 21 positioned on the bottom surface 14 of the groove. The upper clad 23 is formed on the lower clad 21 so as to cover the optical waveguide 22. The upper surface of the upper clad 23 is smooth, and the photodetector 30 is disposed on the upper surface of the upper clad 23 positioned on the optical waveguide 22 (or on the groove 11). The photodetector 30 used in this embodiment has a size of about 300 μm along the width direction of the optical waveguide 22 and about 300 μm along the longitudinal direction of the optical waveguide 22.

The thickness of the lower clad 21, the optical waveguide 22, and the upper clad 23 on the bottom surface 14 of the groove 11 are, for example, more than the spot size of the propagating light. The thickness of the lower clad 21 and the optical waveguide 22 on the inclined surface 12 is decreased from the lower portion to the upper portion. The thickness of the lower clad 21 and the optical waveguide 22 on the upper surface 10a of the substrate 10 positioned above the inclined surface 12 are made be a size that does not satisfy the cut-off conditions of light to be propagated, in view of the materials of the optical waveguide 22 and the clads 21 and 23. The thickness of the upper clad 23 is decreased from the lower portion to the upper portion of the inclined surface 12. The thickness of the upper clad 23 on the upper surface 10a of the substrate 10 also is made be a size that does not satisfy the cut-off conditions.

In this embodiment, since the optical waveguide 22 is formed by spin-coating, the optical waveguide 22 is affected by the inclined surface 12 and forms a smooth arc in the vicinity of the inclined surface 12 so as to be curved along the inclined surface 12. In other words, the curved portion 25 is formed in the step portion 15. The curved portion 25 can be formed easily by spin-coating, but it is not limited to spin-coating. For example, deposition or sputtering can be used to form the curved portion 25, although these methods require a more complicated process than in the case of spin-coating.

Various known materials can be used as the material for the core layer constituting the optical waveguide 22. In this embodiment, the core layer is formed of an organic material. Examples of the organic material are polymer materials such as (1) vinyl based organic molecules, (2) siloxane skeleton polymer and (3) condensation polymerized organic molecules. The material is not limited to organic materials, and the core layer can comprise a multicomponent glass, a semiconductor material, or quartz glass as constituent materials.

As (1) vinyl based organic molecules, polymethyl methacrylate (PMMA), fluorinated PMMA, deuterized PMMA, bridged PMMA, alicyclic group introduced modified PMMA, polyethyl methacrylate and the like can be used, and copolymer of these and other vinyl compounds also can be used. As (2) siloxane skeleton polymer, various modified polysiloxanes can be used. Examples thereof include photosensitive polysiloxane derivatives, modified fluorinated polysiloxane and the like. As (3) condensation polymerized organic molecules, various modified polymer that is modified with a condensation polymer such as fluorinated polyimide, thermosetting polyester, and polycarbonate as the skeleton can be used. Examples thereof include photosensitive fluorinated polyimide, epoxy modified polyester resin, acryl modified polycarbonate or the like, and copolymers comprising these and derivatives thereof can be used. Furthermore, fluorinated polyimide, fluorinated polymethacylate, or fluorinated polysiloxane can be used. On the other hand, as the materials of the clad layers constituting the lower and upper clads 21 and 23, for example, poly fluorinated methyl methacrylate can be used.

In the optical module of this embodiment, the curved portion 25 is provided in a part of the optical waveguide 22, light propagating through the optical waveguide 22 is radiated from the optical waveguide 22 by the curved portion 25, and the radiated light is received by the photodetector 30. Therefore, this embodiment can realize an optical module having excellent mass productivity and assembling properties. In other words, efficient mass production of optical modules can be achieved, as in the case of an ordinary semiconductor production process.

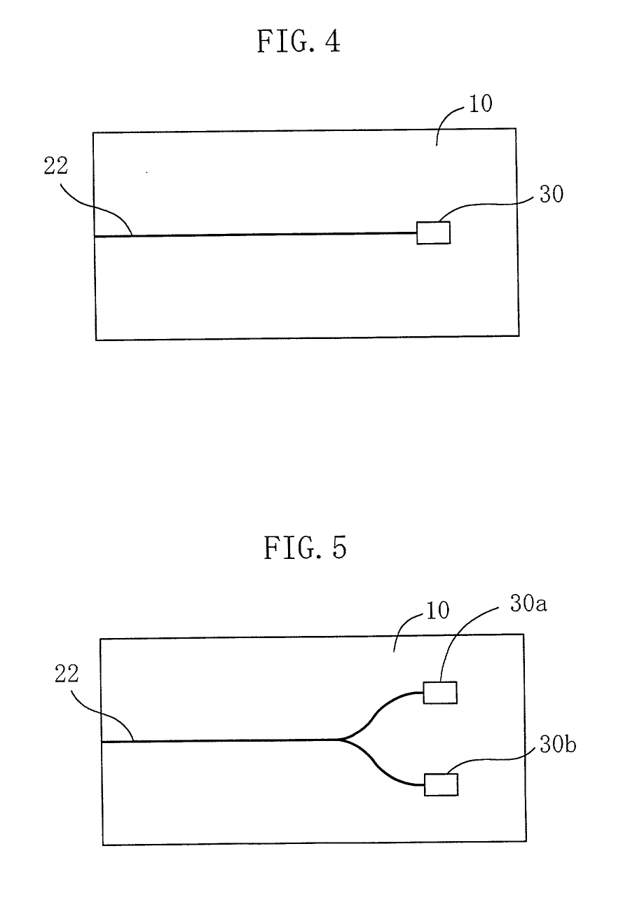

FIG. 4 is a top view showing the structure of the optical module of this embodiment when a photodetector for a wavelength of 1.3 μm or 1.55 μm is used as the photodetector 30. For simplification, FIG. 4 shows only the optical waveguide 22 formed in the groove 11, and the upper clad 23, the groove 11 or the like are not shown. On the other hand, FIG. 5 shows a structure in which the optical waveguide 22 is branched, and a photodetector 30a for a wavelength of 1.3 μm and a photodetector 30b for a wavelength of 1.55 μm are provided.

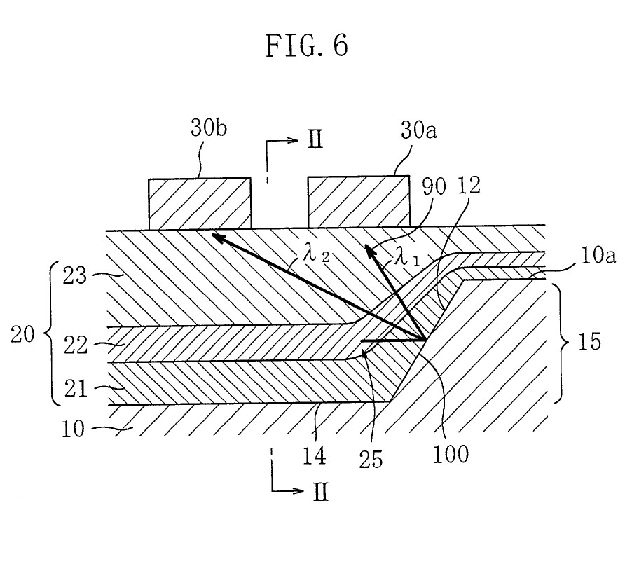

Furthermore, instead of the structure shown in FIG. 5 in which the optical waveguide 22 is branched, a diffraction grating 100 can be formed on the inclined surface 12, as shown in FIG. 6. In the case of this structure, light having a plurality of wavelengths (e.g., λ1, λ2) propagating through the optical waveguide 22 is radiated from the optical waveguide 22 at the curved portion 25. The radiated light is diffracted at different angles depending on the wavelength by the inclined surface 12, and is received by a corresponding photodetector of a plurality of photodetectors 30a and 30b provided on the upper clad 23. For example, the diffraction grating can be designed in such a manner that when λ1 is 1.3 μm and λ2 is 1.55 μm, the signal light of λ1 is received by the photodetector 30a for 1.3 μm, and the signal light of λ2 is received by the photodetector 30b for 1.55 μm.

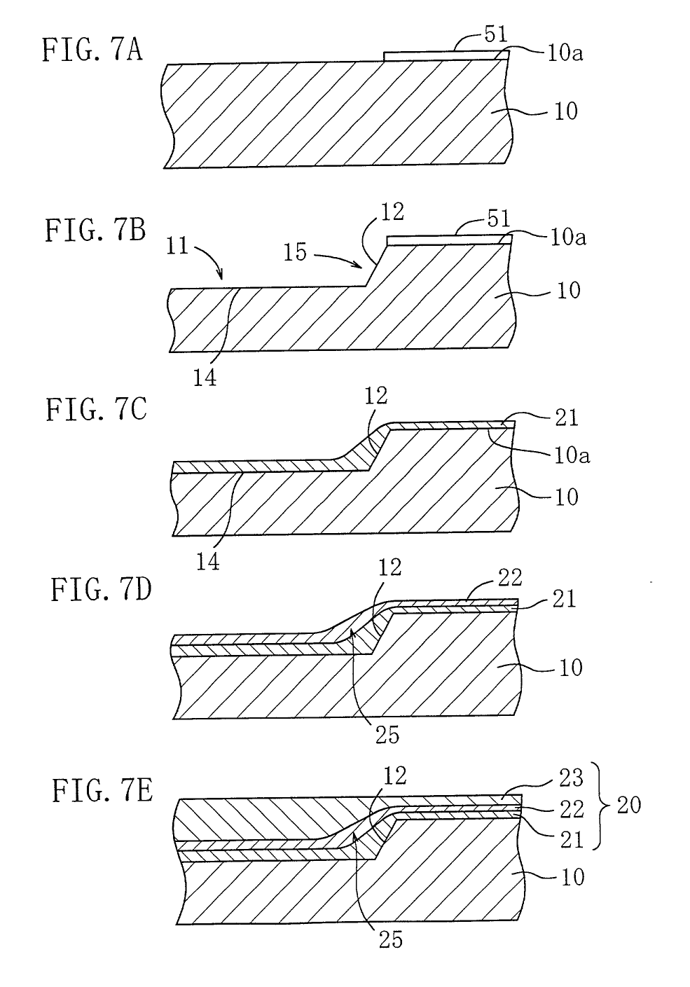

Next, referring to FIGS. 7A to 7E, a method for producing the optical module of this embodiment will be described. FIGS. 7A to 7E are cross-sectional views of a process sequence for illustrating a method for producing the optical module of this embodiment.

First, as the substrate 10, for example, a silicon substrate is prepared, and then a photoresist film 51 is formed in a part of the upper surface 10a of the substrate 10, as shown in FIG. 7A.

Next, as shown in FIG. 7B, etching is performed using the photoresist film 51 as the mask, and thus the step portion 15 including the inclined surface 12 is formed on the substrate 10. The inclined surface 12 is formed by performing anisotropic dry etching, utilizing etching anisotropy of the silicon substrate 10 to expose the (111) plane of the silicon. Since the etching rate on the (111) plane of the silicon is slower than those of other planes, an etching treatment so highly anisotropic that the (111) plane is selectively exposed can be performed. In this process, the groove 11 for defining the optical path of the optical waveguide 22 is formed together with the formation of the inclined surface 12.

In this embodiment, a silicon substrate is used as the substrate 10, but other substrates can be used. In the case where a substrate of a diamond type structure such as silicon substrates, or a substrate of a sphalerite type crystal structure (GaAs substrate) is used, a specific plane can be selectively exposed by anisotropic etching, so that the smooth inclined surface 12 can be formed relatively easily. Alternatively, instead of utilizing anisotropic etching, the inclined surface 12 can be formed by using known processing techniques (e.g., physical processing such as laser processing). In this case, there is no limitation regarding the type of the substrate, and a glass substrate or a metal substrate can be used. In the case of a glass substrate, the substrate can be processed with hydrofluoric acid. In the case of a metal substrate, when the malleability of the metal is excellent, the substrate can be subjected to processing such as pressing.

It is preferable that at least the portion constituting the inclined portion 12 of the substrate 10 is formed of a material having a low refractive index than that of the optical waveguide 22 (or the waveguide body 20). In this embodiment, the substrate 10 is formed of a material having a low refractive index. In the case of this structure, signal light radiated from the optical waveguide 22 is satisfactorily reflected by the inclined surface 12. Furthermore, when the inclination angle of the inclined surface 12 is set so that total reflection of the signal light radiated from the optical waveguide 22 can be achieved, the light can be reflected efficiently by the inclined surface 12. As a result, the light-reception efficiency of the photodetector 30 can be improved.

Furthermore, even if the inclined surface 12 is not formed of a material having a low refractive index than that of the optical waveguide 22, a reflective film (e.g., a metal film) is formed on the surface of the inclined surface 12, so that good reflection by the incline surface 12 can be obtained. When a glass substrate is used as the substrate 10, it is preferable to form a reflective film on the surface of the inclined surface 12. In this case, after the structure shown in FIG. 7B is produced, a photoresist film (not shown) is formed on a region except the inclined surface 12 of the substrate 10. Thereafter, a reflective film is formed on the surface of the exposed inclined surface 12.

When a metal film is formed as the reflective film, there is no limitation regarding the method for forming the film, as long as a smooth metal film is formed. For example, deposition or sputtering can be used. In the case of the structure in which the reflective film is formed, the material of the substrate 10 is not particularly limited to a low refractive index material, so that the range of material selection can be broader. In the case where the substrate 10 is formed of a metal, the same effect as in the structure in which a reflective film is formed on the surface of the inclined surface 12 can be obtained.

When it is desired to provide the inclined surface 12 with a function of wavelength selectivity, after the inclined surface 12 is formed, a diffraction grating may be formed on the inclined surface 12 by known techniques, or a dielectric multilayered film may be formed on the surface of the inclined surface 12.

Next, after the photoresist 51 is removed, as shown in FIG. 7C, a material (e.g., poly fluorinated methyl methacrylate) constituting the lower clad layer 21 is deposited on the substrate 10 so as to cover the inclined surface 12, and the bottom surface 14 and the wall surface 13 of the groove 11 by spin-coating.

Next, as shown in FIG. 7D, a material (e.g., polymer material) constituting the core layer (optical waveguide) 22 is deposited on the lower clad layer 21 by spin-coating. Then, a photoresist (not shown) for defining the shape of the core layer 22 is provided thereon, etching is performed with the photoresist as the mask, so that the core layer 22 having a substantially rectangular cross-section (see FIG. 2) can be obtained. The core layer 22 is formed on the lower clad layer 21 in the step portion 15 including the inclined surface 12 by spin-coating as well, so that the curved portion 25 is formed in this portion. In other words, the core layer 22 is affected by the inclined portion 12 to form a smooth arc in the vicinity of the inclined surface 12 and be curved along the inclined surface 12. Thus, the curved portion 25 is formed in a part of the core layer 22. In view of the production efficiency, it is preferable to use the spin-coating method, but if it is sufficient to form the curved portion 25, other methods such as deposition or sputtering can be used.

Next, as shown in FIG. 7E, a material (e.g., poly fluorinated methyl methacrylate) constituting the upper clad layer 23 is deposited on the lower clad layer 21 so as to cover the core layer 22 by spin-coating, and the upper clad layer 23 having a smooth upper surface is obtained. The upper surface of the upper clad layer 23 becomes the upper surface of the waveguide body 20.

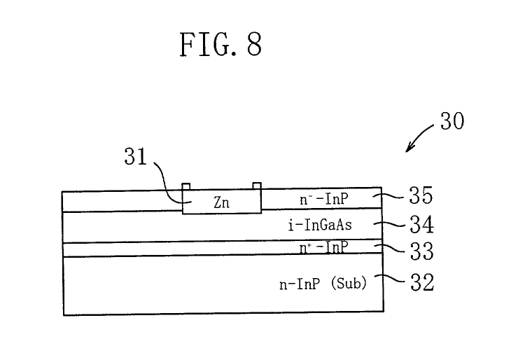

Thereafter, the photodetector 30 is provided in a position of the upper surface of the upper clad layer 23 that is reached by the reflected light by the inclined surface 12, and then the optical module of this embodiment can be obtained. The photodetector 30 of this embodiment used in this embodiment is a photodiode, and is disposed over a region where the groove 11 is formed when viewed from above the optical module. For example, the photodetector 30 is disposed so that the light-receiving portion of the photodetector 30 is positioned above the region where the core layer 22 is formed, when viewed from about the optical module. The photodiode that becomes the photodetector 30 of this embodiment is a pin diode as shown in FIG. 8. The pin diode shown in FIG. 8 includes a laminate and a Zn diffusing layer (light-receiving portion) 31. The laminate comprises an n+-InP layer 33, n+-InP layer (buffer layer), an i-InGaAs layer 34, and an n−-InP layer 35 that are laminated in this order on an n-InP substrate 32. The Zn diffusing layer (light-receiving portion) 31 is formed on a part of the n−-InP layer 35 and is contacted with the i-InGaAs layer 34. The surface in which the Zn diffusing layer 31 is formed is opposed to the upper surface of the upper clad layer 23.

According to a production method of this embodiment, the above-described optical module of this embodiment can be mass-produced efficiently as in the ordinary semiconductor production process. Therefore, low cost optical modules can be provided.

The optical module of this embodiment is configured as a planar lightwave circuit (PLC), so that this module can be compact, compared with discrete type or fiber type optical components. Therefore, the present invention can provide an optical component (optical waveguide element) that can meet a demand for compactness. Furthermore, since the PLC is excellent in high level of integration and high performance, utilizing this advantage, a hybrid integrated circuit device (optical circuit device) such as an optical signal transmitting and receiving module can be realized by further providing a light source (semiconductor laser) in the optical module of this embodiment. In other words, not only an optical module, but also an optical signal transmitting and receiving module can be realized. Furthermore, by using the substrate 10 of this embodiment as the platform of a PLC, the present invention can provide an optical circuit device in which at least one selected from a light source, a splitter, an optical multi/demultiplexer, a semiconductor amplifier, a switch and a modulator is mounted on the platform. These components including the light source can be mounted on a portion other than the substrate 10 to realize an optical circuit device.

Embodiment 2

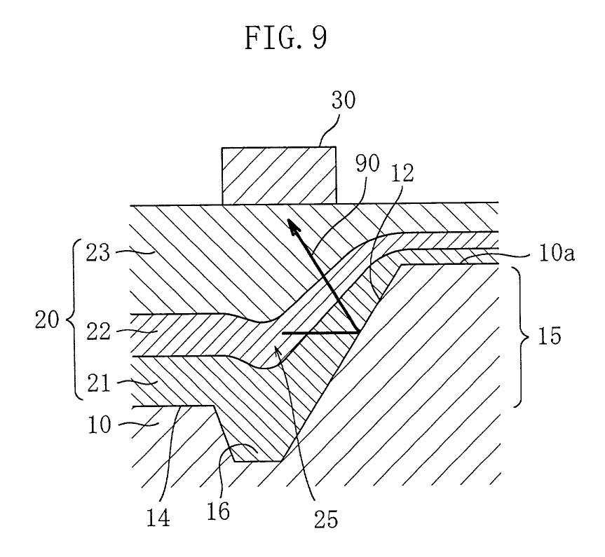

An optical module of Embodiment 2 according to the present invention will be described with reference to FIG. 9. FIG. 9 is a schematic cross-sectional view of the structure of the optical module of this embodiment.

The optical module of this embodiment is different from that of Embodiment 1 in that a recess 16 is formed in the vicinity of the lower portion of the inclined surface 12. The design of other portions is the same as that of Embodiment 1, so that description thereof is omitted or simplified.

In this embodiment, the recess 16 is formed in the vicinity of the lower portion of the inclined surface 12, so that the optical waveguide 22 can be curved downward. The curved portion 25 can be curved to a larger extent by protruding downward a part of the curved portion 25 formed by the effect of the inclined portion 12. Therefore, most of the light signals propagating through the optical waveguide 22 can be radiated from the optical waveguide 22 toward the inclined surface (reflection surface) 12, so that the amount of light reflected by the inclined surface 12 can be increased. In other words, more signal light can be radiated from the optical waveguide 22 to increase the light amount of the signal light received by the photodetector 30. Therefore, the conversion efficiency of light signals to electrical signals in the photodetector 30 can be improved.

In this embodiment, the recess 16 obtained by curving the optical waveguide 22 downward is provided in the position where the bottom surface 14 of the groove and the inclined surface 12 meet. More specifically, the inclined surface 12 is extended further downward than the level of the bottom surface 14 of the groove, and the recess 16 is formed on the bottom surface 14 of the groove in such a manner that the inclined surface 12 becomes a wall surface of the recess 16. The recess 16 along the inclined surface 12 can be formed in the following manner. For example, the structure as shown in FIG. 7B is produced, and then regions other than the region in which the recess 16 is to be formed is masked with a photoresist. Then, the unmasked portions are etched so as to form the recess 16. After the recess 16 is formed, the same processes as shown in FIGS. 7C and 7D are performed, so that the optical waveguide 22 that is curved further downward in the curved portion 25 can be obtained.

In this embodiment, the cross-section of the recess 16 along the longitudinal direction of the optical waveguide has an inverted trapezoidal shape. However, the shape is not limited thereto, and any shape (e.g., semi-spherical) that can curve the optical waveguide 22 downward can be used. In view of forming the lower clad layer 21 by spin-coating, it is preferable that the inclined surface 12 is flush with the wall surface of the recess 16 and the angle formed by the wall surface of the recess 16 and the bottom surface 14 of the groove 11 is an obtuse angle, because coating with the polymer material can be performed satisfactorily. As described in Embodiment 1, a diffraction grating can be formed on the inclined surface 12. The structure shown in FIG. 6 can be applied to the optical module of this embodiment.

Embodiment 3

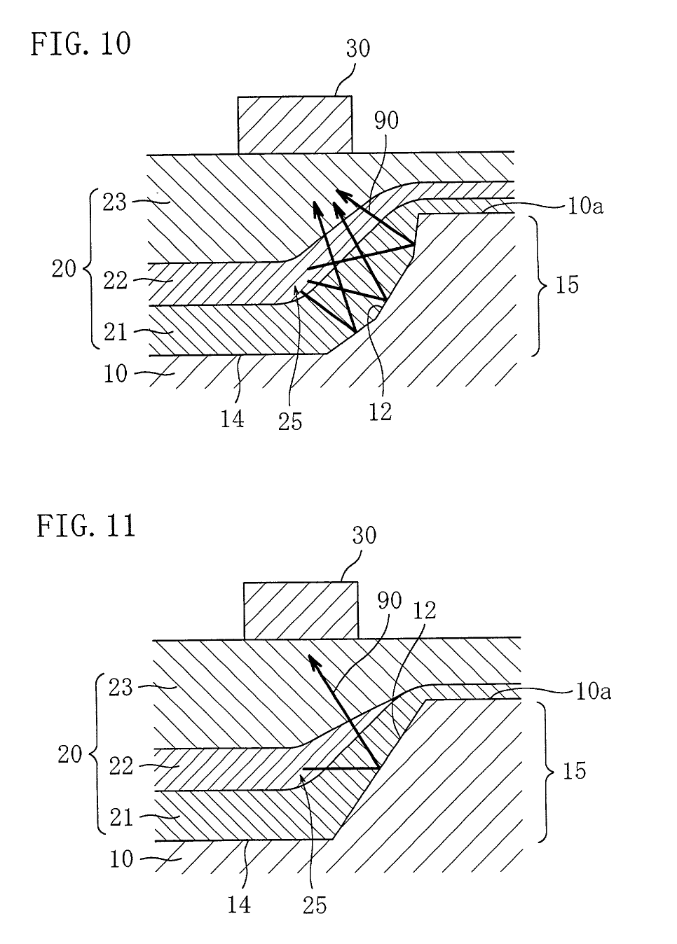

An optical module of Embodiment 3 according to the present invention will be described with reference to FIG. 10. FIG. 10 is a schematic cross-sectional view of the structure of the optical module of this embodiment.

The optical module of this embodiment is different from that of Embodiment 1 in that the inclined surface 12 is recessed in the form of a concave so that reflected light 90 is collected to the photodetector 30. The design of other portions is the same as that of Embodiment 1, so that description thereof is omitted or simplified.

In this embodiment, the inclined surface 12 is recessed in the form of a concave so that the reflected light 90 is collected to the photodetector 30. Therefore, the radiated light 90 from the optical waveguide 22 can be reflected by the inclined surface 12 in a collected state, so that the reflected light 90 in the collected state can be received by the photodetector 30. Thus, the light-reception efficiency of the photodetector 30 can be improved further. In this embodiment, the recessed inclined surface (reflection surface) 12 is formed so that the inclination angle of the inclined surface 12 is changed intermittently. Such an inclined surface 12 can be formed by masking portion except the portion to be etched and performing anisotropic etching several times so that the inclination angle is different from each other. Alternatively, a recessed inclined surface 12 can be formed by physical processing.

In this embodiment, the recessed inclined surface 12 is formed so that the inclination angle of the inclined surface 12 is changed intermittently, but the present invention is not limited thereto. The recessed inclined surface 12 having a continuously changing inclination angle can be formed. Furthermore, in this embodiment, the inclined surface 12 is recessed in the form of a concave along the inclination direction of the inclined surface 12. However, the present invention is not limited thereto, and the inclined surface 12 can be recessed in the form of a concave along the width direction of the optical waveguide 22. Alternatively, a combination thereof can be used. In addition, the structure of this embodiment and the structure of Embodiment 1 or 2 can be combined as appropriate.

Embodiment 4

An optical module of Embodiment 4 according to the present invention will be described with reference to FIG. 11. FIG. 11 is a schematic cross-sectional view of the structure of the optical module of this embodiment.

The optical module of this embodiment is different from that of Embodiment 1 in that the optical waveguide 22 is discontinued in the groove 11. The design of other portions is the same as that of Embodiment 1, so that description thereof is omitted or simplified.

In this embodiment, the optical waveguide 22 is discontinued in the groove 11. More specifically, the optical waveguide 22 does not extend up to the height more than the upper end of the inclined surface 12, but the end of the optical waveguide 22 is positioned within the range between the height of the upper end and the height of the lower end of the inclined surface 12. Even if the optical waveguide 22 is discontinued in the middle of the inclined surface 12, the signal light propagating through the optical waveguide 22 is radiated from the optical waveguide 22 toward the inclined surface 12 by the curved portion 25. Then, the signal light is reflected by the inclined surface 12, and then the reflected light 90 is received by the photodetector 30. No problem is caused in operation, even if the optical waveguide 22 is discontinued without extending to the upper surface 10a of the substrate 10 as in this embodiment. In the case of this structure, since all the signal light propagating through the optical waveguide 22 can be radiated toward the inclined surface 12. Therefore, the light amount of the signal light 90 reflected toward the photodetector 30 can be further increased.

In this embodiment, the thickness of the optical waveguide 22 is decreased gradually from the lower portion to the upper portion of the inclined surface 12. This structure can be formed by, for example, producing the structure shown in FIG. 7D, and then performing an additional process of etching the unnecessary portion of the optical waveguide (core layer) 22. Furthermore, etching can be replaced by physical processing. The above-described structures of Embodiments 1 to 4 can be combined with the structure of Embodiment 4 as appropriate.

Embodiment 5

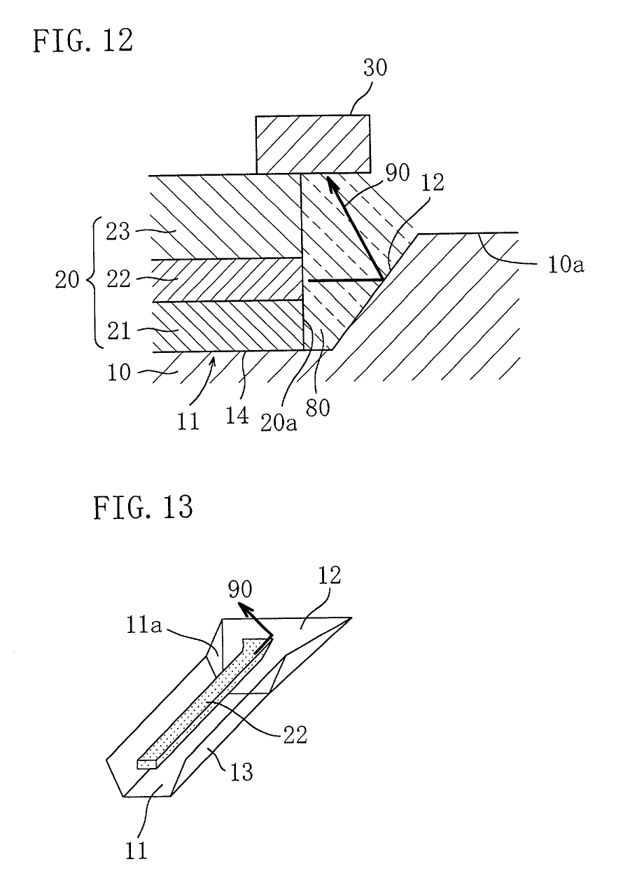

An optical module of Embodiment 5 according to the present invention will be described with reference to FIG. 12. FIG. 12 is a schematic cross-sectional view of the structure of the optical module of this embodiment.

The optical module of this embodiment is different from that of Embodiment 1 in that the light that has propagated through the optical waveguide 22 is allowed to emit from the end face of the optical waveguide 22, and the outgoing light is reflected by the inclined surface 12. In other words, in the above embodiments, the signal light is radiated from the optical waveguide 22 by the curved portion 25, whereas in this embodiment, instead of the curved portion 25, an end face 20a is formed, and through the end face 20a, the light that has been propagated through the optical waveguide 22 is allowed to emit from the optical waveguide 22. The design of other portions is the same as that of Embodiment 1, so that description thereof is omitted or simplified.

In this embodiment, the end face 20a of the waveguide body 20 is positioned in the groove 11, and the end face 20a of the waveguide body 20 is formed so as to be substantially perpendicular to the bottom surface 14 of the groove 11. A suitable gap is provided between the end face 20a and the inclined surface 12, and a uniform medium (e.g., air) 80 is filled in the gap. The end face 20a faces the inclined surface 12, so that the light that has propagated through the optical waveguide 22 emits from the end face 20a and is reflected by the inclined surface 12. Thereafter, the reflected light 90 is received by the photodetector 30 and is converted to electrical signals in the photodetector 30.

Thus, when the end face 20a is provided, all the signal light propagating through the optical waveguide 22 can emit from the end face 20a of the optical waveguide 22. The signal light (guided wave) 90 that has emited propagates in the uniform medium 80 free from interfaces, so that the light can be received reliably by the photodetector 30 without being scattered. Therefore, the signal light can be prevented from being scattered and radiated to the periphery. As a result, optical noise in the peripheral optical elements can be reduced.

When signal light propagates through the optical waveguide 22, for example, in a Gaussian mode, the light can be received by the photodetector 30 without deforming the mode of the signal light. Therefore, the design of the coupling structure between the optical waveguide 22 and the photodetector 30 can be easy. In this embodiment, air is used as the uniform medium 80, so that simply a gap is present between the end face 20a and the inclined surface 12, and the outgoing light from the end face 20a and the reflected light 90 by the inclined surface 12 pass through air as the uniform medium. In other words, a space filled with no special substance is utilized as the uniform medium. As the uniform medium 80, for example, a medium such as quartz glass, organic glass or the like can be used.

When a medium constituted by a substance that absorbs light having a specific wavelength is used as the uniform medium 80, the uniform medium 80 can be provided with an optical function of wavelength selectivity. This makes it possible to perform an advanced treatment such as a treatment of allowing signal light having different wavelengths propagating through the optical waveguide 22 to be selected based on the wavelength and received by the photodetector 30. A diffraction grating or a dielectric multilayered film can be formed on the inclined surface 12 as in Embodiment 1.

Embodiment 6

An optical module of Embodiment 6 according to the present invention will be described with reference to FIG. 13. FIG. 13 is a schematic perspective view of the structure of the optical waveguide 22 and the groove 11 of the optical module of this embodiment.

The optical module of this embodiment is different from that of Embodiment 1 in that the width of the groove 11 is increased gradually from the lower portion to the upper portion of the inclined surface 12. In other words, in this embodiment, in the portion 11a near the inclined surface 12, the width of the groove 11 is increased gradually with approaching the upper end of the inclined surface 12. Each side of the groove is tapered in the vicinity of the inclined surface. The design of other portions is the same as that of Embodiment 1, so that description thereof is omitted or simplified.

As in this embodiment, in the case where the width of the groove 11 is increased in the portion 11a near the inclined surface 12, when the optical waveguide 22 disposed inside the groove 11 is formed by spin-coating, dry-etching or the like, the shape of the optical waveguide 22 can be changed so that the width thereof is increased in the portion 11a near the inclined surface 12. This shape is different depending on the formation conditions or the like. For example, as shown in FIG. 13, in the portion 11a near the inclined surface 12, the width is increased gradually with approaching the inclined surface 12. With such a shape, the amount of the signal light radiated from the optical waveguide 22 can be increased. Therefore, the light-receiving efficiency of the photodetector 30 can be improved.

In this embodiment, the shape of the optical waveguide 22 is changed by increasing the width of the groove 11 in the vicinity of the inclined surface 12. However, the shape of the groove 11 is not limited to a particular shape, as long as the width of the optical waveguide 22 can be increased.

Embodiment 7

An optical module of Embodiment 7 according to the present invention will be described with reference to FIG. 14. FIG. 14 is a schematic cross-sectional view of the structure of the optical module of this embodiment.

The optical module of this embodiment is different from that of Embodiment 1 in that a protrusion 17 for curving the optical waveguide 22 upward is formed in a part of the bottom surface 14 of the groove 11. The design of other portions is the same as that of Embodiment 1, so that description thereof is omitted or simplified.

In the case where the protrusion 17 is formed, the optical waveguide 22 is curved so as to be projected upward by the protrusion 17. This curved portion 25 allows a part of the light signals propagating through the optical waveguide 22 to be radiated upward. The photodetector 30 is provided in the position that is reached by the signal light 90 radiated from the curved portion 25, and the radiated light 90 is received by the photodetector 30 and is converted to electrical signals. In this embodiment, the photodetector 30 is disposed on the upper clad 23 positioned above the curved portion 25. Furthermore, the protrusion 17 is provided on the bottom surface 14 of the groove 11 so as to traverse the groove 11. The cross-sectional shape of the protrusion 17 along the longitudinal direction of the optical waveguide 22 is a triangle (e.g., isosceles triangle).

Unlike Embodiment 1, the light 90 radiated from the optical waveguide 22 is not reflected by the inclined surface 12, and the radiated light 90 is received directly by the photodetector 30. For this reason, the optical waveguide 22 and the photodetector can be optically coupled by a simple structure without considering the effect of the reflection of the inclined surface 12. In the structure of Embodiment 1, light signals propagating in only one direction through the optical waveguide 22 is utilized, whereas in this embodiment, light signals propagating in all the directions can be utilized.

In addition, the signal light propagating through the optical waveguide 22 after passing through the curved portion 25 can be further utilized, so that a plurality of protrusions 17 and a plurality of photodetectors 30 can be formed with respect to one optical waveguide 22. In such a structure, if the radiated light 90 from each curved portion 25 generated by a corresponding protrusion 17 is designed to be received by a corresponding photodetector 30 via a filter having a wavelength selectivity or the like, signal light having different wavelengths propagating through the optical waveguide 22 is selected based on the wavelength and received by a corresponding photodetector 30. Therefore, with a simple structure, optical divides for optical wavelength division multiplex communication systems (optical devices for WDM) can be realized.

In this embodiment, the protrusion 17 has a triangular cross-section. However, the shape of the protrusion 17 is not limited thereto. Any shapes can be used for the protrusion 17, as long as it can deform the optical waveguide 22 so as to radiate the signal light from the optical waveguide 22. An inclined surface constituting the protrusion 17 is not necessarily smooth, and any one of the surfaces or all the surfaces can be recessed in the form of a concave, or a stepped portion having many steps can be provided. Furthermore, when the cross-sectional shape is left-right symmetrical, such as an isosceles triangle, the light-reception efficiency of light signals in both directions can be substantially the same. Alternatively, the light-reception efficiency of light signals in both directions can be made different by making the cross-sectional shape asymmetrical.

Furthermore the recess 16 (see FIG. 9) of Embodiment 2 is provided in the vicinity of the protrusion 17, so that the curved portion 25 is curved more significantly. With such a recess 16, the light amount of the signal light radiated from the optical waveguide 22 can be increased. The recess 16 can be provided in both sides or either one side of the propagation direction of the signal light. In the case where the recesses 16 are formed on both sides of the protrusion 17, when the shape of a combination of the protrusion 17 and the recesses 16 positioned on both sides of the protrusion 17 are left-right symmetrical, the light reception efficiency of the light signals propagating in both directions can be substantially the same. In addition, not only the protrusion 17, but also a recess or any other shapes can be used, as long as the shape can deform the optical waveguide 22 so as to radiate the signal light from the optical waveguide 22.

Embodiment 8

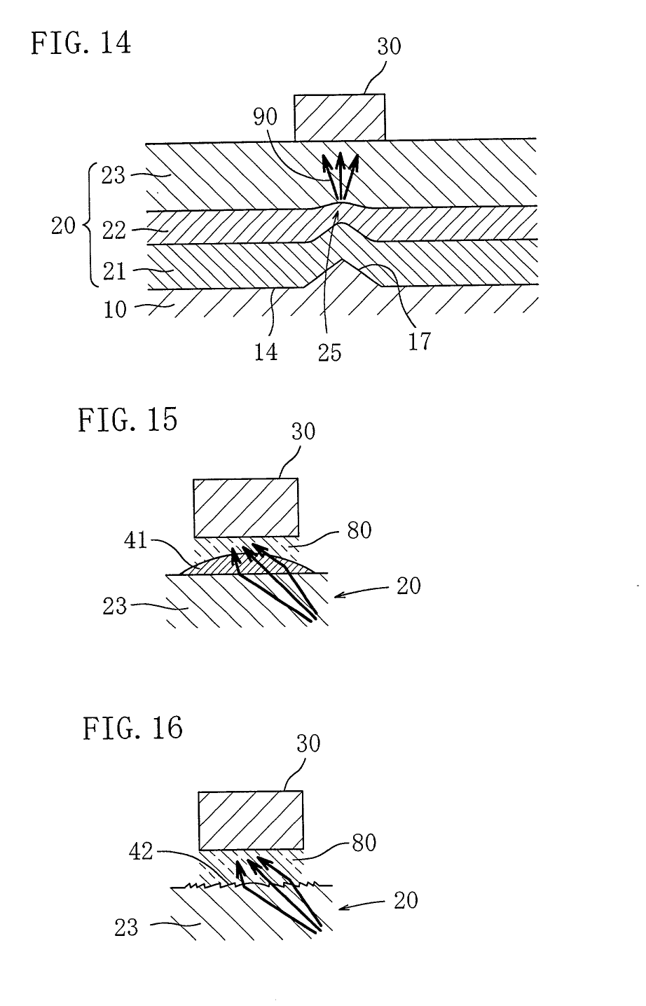

An optical module of Embodiment 8 according to the present invention will be described with reference to FIG. 15. FIG. 15 is a schematic cross-sectional view of the structure of the periphery of the photodetector 30 of the optical module of this embodiment.

The optical module of this embodiment is different from that of Embodiment 1 in that light collected by a light collecting member 41 is received by the photodetector 30. The design of other portions is the same as that of Embodiment 1, so that description thereof is omitted or simplified.

In this embodiment, a light collecting member 41 for collecting the signal light (including reflected light) radiated from the optical waveguide 22 is provided. Therefore, even if the distance from the point of radiation of the signal light from the optical waveguide 22 to the photodetector 30 is so long that the light is diffused, the signal light can be collected by the light collecting member 41. Thus, even in such a case, the photodetector 30 can receive light efficiently.

FIG. 15 shows a structure in which a convex lens (convex lens structure) 41 is used as the light collecting member between the waveguide body 20 (or the upper clad 23) and the photodetector 30. A uniform medium 80 is provided between the convex lens 41 and the photodetector 30. As the uniform medium 80, for example, matching oil can be used. Alternatively, the same material as that of the upper clad 23 can be used. Furthermore, the uniform medium 80 can be air. In this case, a space between the convex lens 41 and the photodetector 30 can be provided by using a suitable supporting member (not shown).

In the structure shown in FIG. 15, the convex lens 41 is used, but the present invention is not limited thereto, and a concave lens (concave lens structure) can be used. Furthermore, as shown in FIG. 16, instead of the convex lens 41, a Fresnel lens (Fresnel lens structure) 42 can be used. “Fresnel lens” refers to a lens on a plane that utilizes diffraction phenomenon of light. When the Fresnel lens 42 is provided, the signal light radiated from the optical waveguide 22 is collected by the Fresnel lens, propagates in the uniform medium 80, and then is received by the photodetector 30. As described above, the uniform medium 80 may be air.

Then the Fresnel lens 42 is used as the light collecting member, the protrusion extent is small and the lens is smooth, compared with the structure in which the convex lens 41 shown in FIG. 15 is used. Therefore, the subsequent processes such as assembling of the photodetector 30 can be performed easily. Furthermore, the Fresnel lens 42 can be realized by forming a predetermined pattern on the surface of the upper clad 23. Thus, the production can be performed in a simplified manner.

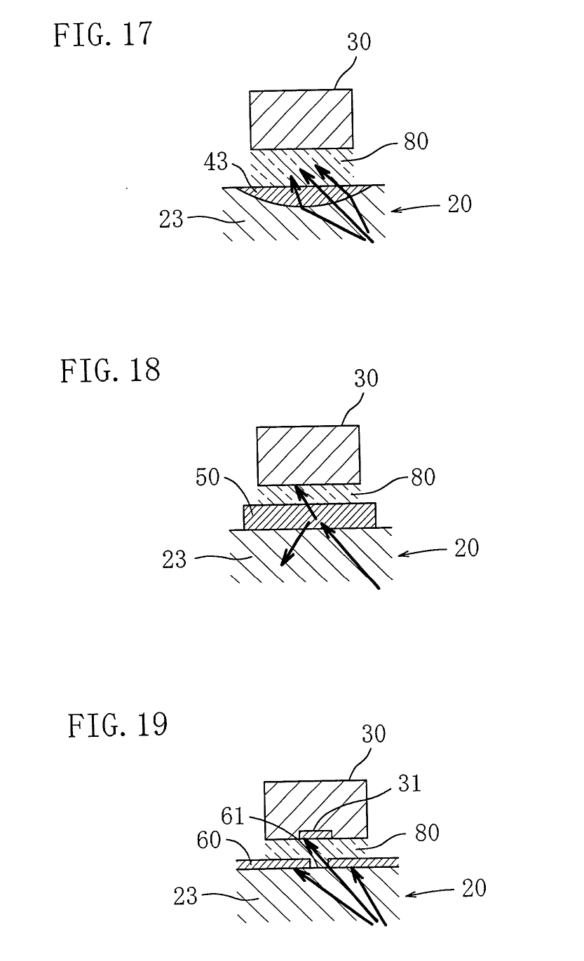

Furthermore, as shown in FIG. 17, a low refractive index portion 43 made of a material having a lower refractive index than that of the upper clad 23 surrounding this portion is formed in the surface of the upper clad 23 opposed to the photodetector 30. The low refractive index portion 43 can function as the light collecting member. The low refractive index portion 43 can be formed by subjecting the upper clad 23 to ion implantation, impurity diffusion or the like to make the refractive index smaller than that of the periphery. The signal light radiated from the optical waveguide 22 is received efficiently by the photodetector 30 through the medium 80 while maintaining the state where the light is collected by the low refractive index portion 43. In this structure as well, the surface of the upper clad 23 is smooth, so that the subsequent processes such as a process of assembling the photodetector 30 or the like can be easy. In addition, the production can be performed in a simplified manner.

Embodiment 9

An optical module of Embodiment 9 according to the present invention will be described with reference to FIG. 18. FIG. 18 is a schematic cross-sectional view of the periphery of the photodetector 30 of the optical module of this embodiment.

The optical module of this embodiment is different from that of Embodiment 1 in that an optical functional member 50 for selectively transmitting or absorbing light of a specific wavelength is formed between the photodetector 30 and the upper clad 23. The design of other portions is the same as that of Embodiment 1, so that description thereof is omitted or simplified.

In this embodiment, a dielectric multilayered film obtained by laminating layers having different dielectric constants periodically is used as the optical functional member 50. When this dielectric multilayered film 50 is designed to reflect only light having a wavelength of 1.55 μm, this film can function as follows. For example, even if mixed light signals of wavelengths of 1.3 μm and 1.55 μm propagate through the optical waveguide 22 and are reflected by the inclined surface 12, the signal light of a wavelength of 1.55 μm is reflected by the dielectric multilayered film 50 before reaching the photodetector 30. Therefore, the signal light of a wavelength of 1.55 μm is not received by the photodetector 30. On the other hand, the signal light of a wavelength of 1.3 μm passes through the dielectric multilayered film 50, so that the photodetector 30 can receive the light. Thus, when the dielectric multilayered film 50 is provided as the optical functional member, this can realize an optical module that can select the wavelength of the light signal to be received by the photodetector 30.

In this embodiment, the dielectric multilayered film 50 for use as a filter is provided on the upper surface of the upper clad 23, so that when the waveguide body 20 is in a wafer state, the dielectric multilayered film 50 for use as a filter easily can be provided on the upper surface of the waveguide body 20. In other words, a reflective filter can be formed on the waveguide body 20 in the state where the waveguide body 20 is formed on the substrate 10. On the other hand, in the case of the conventional structure shown in FIG. 22, in order to provide the filter 105 perpendicular to the optical waveguide 101, it is necessary to form a slit groove in the substrate 107 and to insert the filter in the groove, or it is necessary to deposit a substance that becomes the filter on the end face of the optical waveguide 101. The structure of this embodiment eliminates such necessity so that an optical module having a mass productivity can be realized.

In this embodiment, the dielectric multilayered film 50 is used as the optical functional member, but the present invention is not limited thereto. For example, the optical functional member having a wavelength selectivity can be formed by depositing a material absorbing light of a predetermined wavelength on the upper surface of the upper clad 23. In this case as well, the optical functional member can be formed on the surface of the optical waveguide body 20 in a wafer state, so that this embodiment is excellent in mass productivity. In addition, when a resin is used as the light absorbing maternal, the optical functional member can be formed by a simple method of applying the resin onto the optical waveguide body 20 in a wafer state. Alternatively, the optical functional member can be formed by disposing the photodetector 30 with a suitable gap with respect to the surface of the upper clad 23 and inserting a resin having a suitable wavelength selectivity therebetween.

Thus, according to the structure of this embodiment, the photodetector 30 is disposed above the waveguide body 20, so that a function such as wavelength selectivity can be provided easily. Therefore, an optical module (optical circuit device) having a high optical function can be obtained without compromising the excellent mass productivity that can be realized by a semiconductor production process.

The present invention is not limited to the structure in which the optical functional member 50 is provided between the upper surface of the upper clad 23 and the photodetector 30, and the upper clad 23 itself can be provided with the optical functionality. To achieve such a structure, for example, the upper clad 23 may be formed of a material absorbing light of a predetermined wavelength. In this case, the light having a wavelength absorbed by the upper clad 23 is gradually attenuated while the signal light is propagating through the optical waveguide 22. Then, the light is radiated from the curved portion 25 of the optical waveguide 22, and reflected by the inclined surface 12, or the signal light radiated directly to the upper clad 23 propagates in the upper clad 23 again. During these processes, the light having the wavelength can be further attenuated. As a result, only the light except the component of the wavelength absorbed by the upper clad 23 is received by the photodetector 30. Thus, when the upper clad 23 itself has the optical functionality, the signal light can be modulated both in a guided wave mode in which the signal light is propagating through the optical waveguide 22 and in radiation mode in which the signal light is propagating through the upper clad 23.

This embodiment may be of a structure in which the reflected light 90 by the inclined surface 12 is received by the photodetector 30, as shown in Embodiments 1 to 6. Alternatively, the photodetector 30 may receive directly the radiated light from the optical waveguide 22, as shown in Embodiment 7.

Embodiment 10

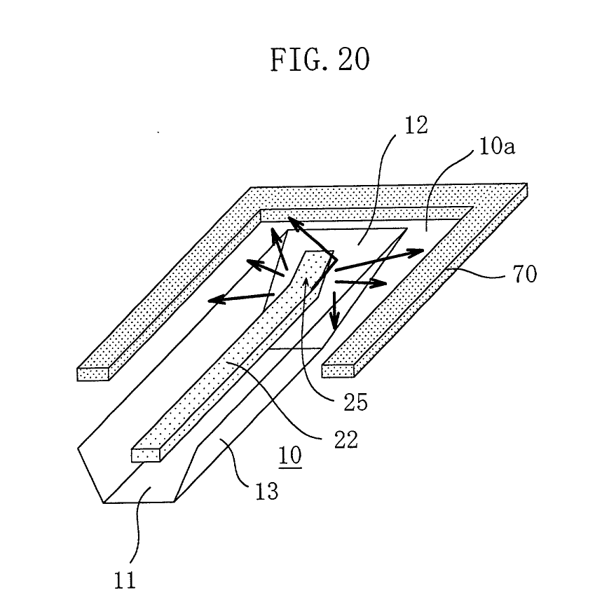

An optical module of Embodiment 10 according to the present invention will be described with reference to FIG. 19. FIG. 19 is a schematic cross-sectional view of the periphery of the photodetector 30 of the optical module of this embodiment.

The optical module of this embodiment is different from that of Embodiment 1 in that a shielding portion 60 having a window 61 for passing light through is provided on the surface of the waveguide body 20 (on the surface of the upper clad 23). The design of other portions is the same as that of Embodiment 1, so that description thereof is omitted or simplified.

In this embodiment, the shielding portion 60 having the window 61 in its center is formed on the surface of the upper clad 23, and therefore the signal light that is radiated from the optical waveguide 22 and propagates through the upper clad 23 emits only from the window 61 of the shielding portion 60, and is received by the photodetector 30 via a uniform medium 80. Therefore, portions other than the predetermined light-receiving portion 31 of the photodetector 30 can be prevented from being irradiated with the signal light. If the light enters the portions to which the electric field is not applied other than the light-receiving portion 31 of the photodetector 30, a current component that delays the response rate of the photodetector 30 may be generated. However, in this embodiment, as a result of the above-described structure, this problem can be avoided so that the deterioration of the frequency characteristics of the photodetector 30 can be suppressed.

The shielding portion 60 of this embodiment can be formed by a known technique such as metal deposition, sputtering or the like. This embodiment may be of a structure in which the reflected light 90 by the inclined surface 12 is received by the photodetector 30, as shown in Embodiments 1 to 6. Alternatively, the photodetector 30 may receive directly the radiated light from the optical waveguide 22, as shown in Embodiment 7. Furthermore, the medium 80 between the shielding portion 60 and the photodetector 30 may be air.

Embodiment 11

An optical module of Embodiment 11 according to the present invention will be described with reference to FIG. 20. FIG. 20 is a schematic perspective view of the periphery of the optical waveguide 22 and the inclined surface 12 of the optical module of this embodiment.

The optical module of this embodiment is different from that of Embodiment 1 in that a light-shielding portion 70 for shielding light is provided in the periphery of the inclined surface 12. The design of other portions is the same as that of Embodiment 1, so that description thereof is omitted or simplified.

In this embodiment, the light-shielding portion 70 is provided on the upper surface 10a of the substrate positioned in the periphery of the inclined surface 12, and the light-shielding portion 70 is formed of a resin absorbing light or the like. Furthermore, the light-shielding portion 70 includes a portion extending straight and parallel to the upper end of the end face (the inclined portion 12) of the groove 11, and a portion extending straight from both ends of that portion along the wall surface 13 of the groove 11. The light-shielding portion 70 has a so-called “U-shape”.

In this embodiment, the U-shaped light-shielding portion 70 is formed in the periphery of the inclined surface 12, and therefore the following advantages can be provided. When the signal light propagating through the optical waveguide 22 disposed in the groove 11 is radiated from the curved portion 25 and reflected by the inclined surface 12, not all the light is directed to the photodetector 30 above, but some light is scattered around in various directions. In this embodiment, the light-shielding portion 70 made of, for example a light-absorbing resin can absorb such scattered light. As a result, the scattered light is prevented from propagating through the waveguide body 20 or the substrate 10, so that an adverse effect such as optical noise on other optical components disposed in the periphery can be prevented.

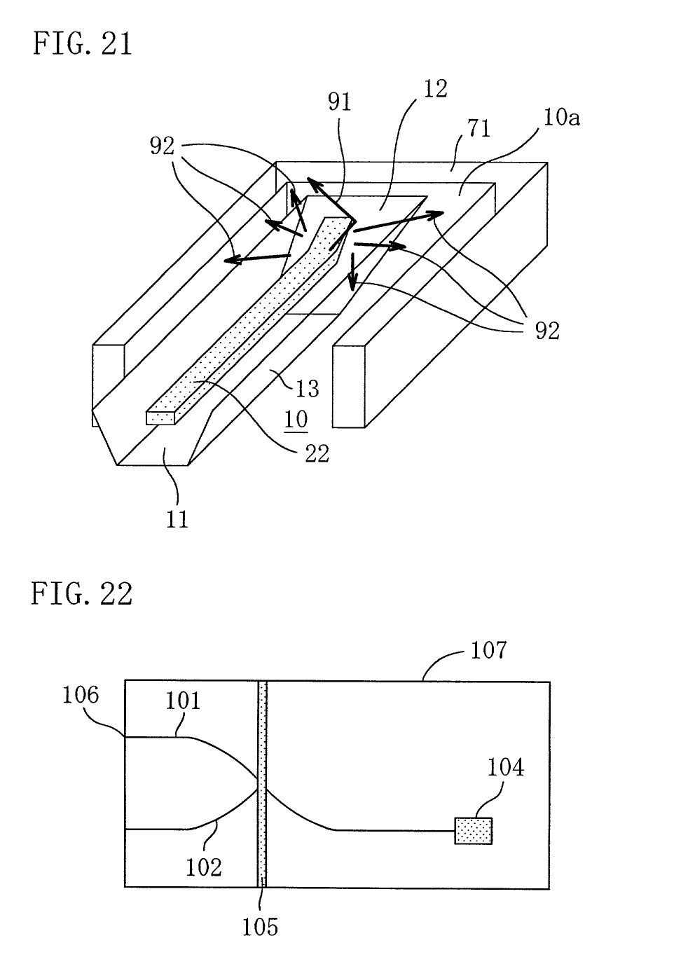

In this embodiment, the light-shielding portion 70 made of a light-absorbing resin is provided, but the present invention is not limited thereto. As shown in FIG. 21, the light-shielding portion also can be constituted by forming a groove portion 71 on the upper surface 10a of the substrate 10 positioned in the periphery of the inclined surface 12. In other words, the light-shielding portion can be constituted by the space in the groove portion 71. The light-shielding portion 71 of this structure can provide the same advantages as those of the light-shielding portion 70. The light-shielding portion of the groove portion 71 can be formed simply by etching the substrate 10, and therefore this is advantageous in that the production is simple. Moreover, the effect of absorbing scattered light can be enhanced by combining the light-shielding portion 70 made of light-absorbing resin or the like and the light-shielding portion 71 of the groove portion.

In the case where the light is reflected by the inclined surface 12 as in Embodiment 1, the light-shielding portion may be formed in the periphery of the inclined surface 12. However, in the case of the structure as in Embodiment 7 (see FIG. 14), the light-shielding portion may be formed in the substrate 10 positioned in the periphery of the protrusion 17 formed in the bottom surface of the groove 11 .

The present invention has been described with reference to Embodiments 1 to 11. However, each of the above embodiments can be combined with other embodiments as appropriate, if necessary. In the above-described embodiments, the waveguide body 20 is disposed on the substrate 10. However, even if an arbitrary layer is provided between the substrate 10 and the waveguide body 20, the above effects can be obtained as well. The structures of Embodiments 1 to 11 can be applied not only to a light-receiving module suitably, but also to an optical module for receiving and transmitting light. According to the above-described embodiments, an optical module having excellent mass productivity can be provided, and therefore a low cost optical communication terminal can be realized. As a result, the present invention can contribute to the development of the optical subscriber communication network in advanced information society.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An optical module comprising:
a substrate;
a waveguide body disposed on the substrate, the waveguide body including an optical waveguide for propagating light; and
a photodetector,
wherein a curved portion for radiating light propagating through the optical waveguide from the optical waveguide is provided in a part of the optical waveguide, and
the photodetector receives light radiated by the curved portion.

2. The optical module of claim 1, wherein
a step portion including an inclined surface is provided in a part of the substrate,
the curved portion of the optical waveguide is a site at which the optical waveguide is curved by the step portion, and
light radiated from the optical waveguide is reflected by the inclined surface of the step portion and is received by the photodetector.

3. The optical module of claim 2, wherein
the optical waveguide is formed in a groove provided in the substrate, and the inclined surface is positioned in the groove.

4. The optical module of claim 2, wherein
a recess for curving the optical waveguide downward is provided in a vicinity of a lower portion of the inclined surface in the substrate.

5. The optical module of claim 2, wherein
the inclined surface of the step portion is recessed in a form of a concave so that reflected light is collected to the photodetector.

6. The optical module of claim 2, wherein
the optical waveguide does not extend up to a height more than an upper end of the inclined surface, and an end of the optical waveguide is present within a range between a height of the upper end and a height of a lower end of the inclined surface.

7. The optical module of claim 2, wherein
a width of the groove is increased from a lower portion to an upper portion of the inclined surface.

8. The optical module of claim 2, wherein
a refractive index of a portion of the substrate that constitutes the inclined surface is lower than that of the optical waveguide, and
the inclined surface is disposed in the groove under conditions for total reflection of light radiated from the optical waveguide.

9. The optical module of claim 2, wherein
a reflective film for reflecting light radiated from the optical waveguide is formed on a surface of the inclined surface.

10. The optical module of claim 2, wherein
a diffraction grating is formed on a surface of the inclined surface.

11. The optical module of claim 2, wherein
a dielectric multilayered film obtained by laminating layers having different dielectric constants is formed on a surface of the inclined surface.

12. The optical module of claim 1, wherein
the optical waveguide is formed in a groove provided in the substrate,
a protrusion or a recess for curving the optical waveguide downward or upward is formed in a part of a bottom surface of the groove, and
the photodetector is provided in a position that is reached by light radiated from the curved portion formed in the protrusion or the recess.

13. The optical module of claim 12, wherein
a plurality of protrusions or recesses with respect to one optical waveguide are formed, and
a plurality of photodetectors are provided corresponding to the plurality of protrusions or recesses.

14. The optical module of claim 1, further comprising a light collecting member for collecting light,
wherein the light collecting member collects light radiated from the curved portion and to be received by the photodetector, and
the photodetector receives the collected light via the light collecting member.

15. The optical module of claim 14, wherein the light collecting member is selected from the group consisting of a convex lens, a concave lens, and a Fresnel lens.

16. The optical module of claim 14, wherein the light collecting member is a member having a light collecting function and made of a material having a different refractive index from that of a portion surrounding the light collecting member.

17. The optical module of claim 1, further comprising an optical functional member for selectively transmitting or absorbing light of a specific wavelength,
wherein the optical functional member is a dielectric multilayered film obtained by laminating layers having different dielectric constants, and
the photodetector receives light radiated by the curved portion via the optical functional member.

18. The optical module of claim 1, further comprising an optical functional member for selectively transmitting or absorbing light of a specific wavelength,
wherein the optical functional member is made of a material that absorbs only a specific wavelength, and
the photodetector receives light radiated by the curved portion via the optical functional member.

19. The optical module of claim 2, wherein
a light-shielding portion for shielding light is provided in a periphery of the inclined surface, and
the light-shielding portion shields light scattered after reflected by the inclined surface.

20. The optical module of claim 19, wherein
the light-shielding portion is made of a material absorbing light.

21. The optical module of claim 19, wherein
the light-shielding portion is a groove portion provided in the substrate.

22. An optical module comprising:
a substrate;
a waveguide body disposed on the substrate, the waveguide body including an optical waveguide for propagating light; and
a photodetector,
wherein the optical waveguide includes an end face from which the light propagating through the optical waveguide emits from the optical waveguide,
an inclined surface for reflecting the light that has emited from the end face to the photodetector is provided on the substrate, and
the photodetector receives light reflected by the inclined surface.

23. The optical module of claim 22, wherein
a medium made of a material absorbing light of a specific wavelength is provided between the inclined surface and the photodetector.

24. The optical module of claim 22, wherein
a light-shielding portion for shielding light is provided in a periphery of the inclined surface, and
the light-shielding portion shields light scattered after reflected by the inclined surface.

25. An optical circuit device comprising:
a light source;
an optical waveguide for propagating light emitted from the light source; and
a photodetector,
wherein a curved portion for radiating light propagating through the optical waveguide is provided in the optical waveguide, and
the photodetector receives light radiated by the curved portion.

26. The optical circuit device of claim 25, wherein
the light source is a semiconductor laser device,
the optical waveguide is a planar lightwave circuit,
the photodetector is a photodiode,
the light source, the optical waveguide and the photodetector are provided on a platform, thereby constituting an optical integrated circuit, and
the optical integrated circuit further comprises at least one selected from the group consisting of a splitter, an optical multi/demultiplexer, a semiconductor amplifier, a switch and a modulator.

27. A method for producing an optical module comprising the steps of:
preparing a substrate;
forming a groove on an upper surface of the substrate, the groove including a wall surface that is one end of the groove and an inclined surface inclining with respect to a normal line of the substrate;
depositing sequentially a material for a clad layer and a material for an optical waveguide on a bottom surface of the groove and the inclined surface, thereby forming the optical waveguide having a curved portion in a step portion including the bottom surface of the groove and the inclined surface; and
providing a photodetector for receiving light radiated by the curved portion of the optical waveguide in a position that is reached by the light on the substrate surface.

28. The method for producing an optical module of claim 27, wherein
the step of preparing the substrate is a step of preparing a semiconductor substrate,
the step of forming a groove includes a step of performing an anisotropic etching treatment with respect to the substrate, and
the material for the optical waveguide is a polymer material.

29. The method for producing an optical module of claim 27, wherein
the step of preparing the substrate is a step of preparing a glass substrate, and
a step of forming a reflective film on the inclined surface is performed after the step of forming the groove and before the step of forming the optical waveguide.
